(19) United States
(12) Patent Application Publication
(10) Pub. No.: US 2023/0334524 A1
(43) Pub. Date: Oct. 19, 2023

(54) GENERATING A MODEL DETERMINING QUALITY OF A CONTENT ITEM FROM CHARACTERISTICS OF THE CONTENT ITEM AND PRIOR INTERACTIONS BY USERS WITH PREVIOUSLY DISPLAYED CONTENT ITEMS

(71) Applicant: Meta Platforms, Inc., Menlo Park, CA (US)

(72) Inventors: Alexandre Paul Sahyoun, San Francisco, CA (US); Lei Wang, Sunnyvale, CA (US); Huihui Wang, Redwood City, CA (US); Chao Zhang, Fremont, CA (US)

(21) Appl. No.: 16/452,108

(22) Filed: Jun. 25, 2019

(51) Int. Cl. G06Q 30/02; G06N 20/00

(52) U.S. Cl. CPC G06Q 30/0246; G06N 20/00; G06Q 30/0277; G06Q 30/0275

(57) ABSTRACT

An online system presenting sponsored content items to users obtains information about quality of the sponsored content items from users to whom the sponsored content items are presented. For example, a user hiding a sponsored content item or reporting a sponsored content item to the online system describe quality of the sponsored content item. By correlating ratings of a sponsored content item by professional raters with a quality ratio of number of reports of the sponsored content item by users to a sum of number of times the sponsored content item was hidden and the number of reports of the sponsored content item, the online system trains a model to determine the quality ratio for sponsored content items based on characteristics of the sponsored content items. When selecting sponsored content items for a user, the online system penalizes or subsidizes a sponsored content item based on its determined quality ratio.

### BACKGROUND

This disclosure relates generally to display of content by an online system, and more specifically to generating a measure of quality of a content item from characteristics of the content item and prior interactions by users with previously displayed content items.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

When selecting content items for presentation, many online systems employ selection processes that select content items with which a user is likely to interact. An online system may account for a quality of a content item, which indicates a likelihood of users interacting with the content item when presented, when selecting content items for presentation. When determining quality of a sponsored content items, many online systems present the sponsored content items to one or more reviewers, who provide a rating or assessment of the quality of a sponsored content item. However, evaluation by one or more reviewers may result in ratings or assessments of quality that are biased or influenced by tastes or preferences of specified raters reviewing the sponsored content items, resulting in ratings or measures of quality more subjectively influenced by the particular raters reviewing the sponsored content items.

### SUMMARY

An online system obtains content items from one or more users for presentation to other users. A content item obtained from a user includes text data, audio data, image data, video data, or any combination thereof for presentation to other users via the online system. One or more of the content items obtained by the online system are sponsored content items. A sponsored content item includes content for presentation to a user and a bid amount specifying an amount of compensation received by the online system from a user from whom the online system obtained the sponsored content item if content from the sponsored content item is displayed to another user or if the other user performs a specific action after the content from the sponsored content item is displayed to the other user.

The online system displays one or more of the sponsored content items to users of the online system and receives interactions by users with sponsored content items form the set. For example, the online system includes one or more sponsored content items in a feed of content generated for a user and displayed to a user. When a user interacts with a sponsored content item from the set via a client device, the client device transmits an identifier of the user, an identifier of the sponsored content item of the set, and a description of the interaction to the online system, which stores the description of the interaction in association with the identifier of the user and the identifier of the sponsored content item. This allows the online system to maintain a log of various interactions with the sponsored content item.

Certain interactions by users with sponsored content indicate that users perceive the sponsored content items to be of low quality, such as uninteresting, irrelevant, or offensive content. For example, a user hides a sponsored content item after being presented with the sponsored content item. As another example, a user reports a sponsored content item to the online system to indicate that the user finds the sponsored content item to be inappropriate or offensive. When reporting a sponsored content item to the online system, a user identifies the sponsored content item and provides a reason for reporting the sponsored content item (e.g., the user finds the sponsored content item to be offensive, inappropriate, misleading, prohibited content, etc.) in some embodiments. Alternatively, a user identifies the sponsored content item and reports the sponsored content item to the online system without providing a reason for reporting the sponsored content item. In other embodiments, users may perform any other suitable interaction with a sponsored content item to indicate that the user considers the sponsored content item to be of low quality.

When presenting content to users, the online system accounts for perceived quality of the content items by various users to present content items to users with which the users are more likely to interact. However, quality of a content item is subjective to individual users. For example, one user may hide a particular sponsored content item because it is related to a topic that is not relevant to the user, while the particular sponsored content item may be related to a topic that is highly relevant to another user. To account for varying user assessments of quality of a sponsored content item to different users, the online system records different types of interactions by users with sponsored content items to calculate a quality ratio for different sponsored content items. In various embodiments, the online system uses a number of times that a content item has been reported to the online system by users and a number of times that the content item has been hidden by users when presented to calculate the quality ratio. As an example, the online system calculates the quality ratio for a content item as a ratio of a number of times that the content item has been reported to the online system by users to a sum of the number of times that the content item has been hidden by users and the number of times that the content item has been reported to the online system. The online system may calculate the quality ratio for a sponsored content item based on interactions with the content item within a specific time interval, such as within a threshold amount of time from a time when the quality ratio is calculated, in some embodiments. Alternatively, the online system calculates the quality ratio from cumulative interactions with a sponsored content item that the online system received since the online system initially displayed the sponsored content item to a user to the time when the online system calculates the quality ratio.

Using previously determined quality ratios calculated for each of a set of content items displayed to users, the online system trains a machine learning model that predicts a quality ratio for a sponsored content item based on characteristics of the sponsored content item. The online system generates the machine learning model from characteristics of each content item of the set and corresponding quality ratios calculated for each content item of the set. In various embodiments, the online system selects the set of content items as content items that have been displayed to at least a threshold number of users. Alternatively, the online system selects the set of content items as content items for which the online system has received at least a threshold number of interactions. In another example, the online system selects the set of content items as content items that have been displayed to users for at least a threshold amount of time. However, the online system may select the set of content items using any suitable criteria in various embodiments.

To train the machine learning model that determines a quality ratio for a sponsored content item, the online system fits the machine learning model to a training set of sponsored content items and their previously determined quality ratios. For example, the online system may use back propagation to train the machine learning model if it is a neural network, or the online system may use curve fitting techniques if the machine learning model is a linear regression. Application of the machine learning model to the sponsored content items of the set generates a determined quality ratio for different sponsored content items of the set. The machine learning model may use any suitable characteristics of a sponsored content item of the set to generate the determined quality ratio for the sponsored content item in various embodiments (such as previous interactions with other sponsored content items obtained from the same user, with other sponsored content items having a common topic or keyword, or with other sponsored content items having at least a threshold number of targeting criteria matching targeting criteria of the sponsored content item).

Generating the machine learning model allows the online system to predict a quality ratio for a sponsored content item based on characteristics of the sponsored content item rather than from received interactions with the sponsored content item. This use of characteristics of the sponsored content item to determine the quality ratio prevents users from biasing the quality ratio for a sponsored content item by hiding or by reporting the sponsored content item a disproportionate number of times. For example, when the online system displays a sponsored content item from a publishing user to other users, users competing with the publishing user hide and report the sponsored content item, resulting in numbers of times the sponsored content item was hidden or was reported that is disproportionately high. This may allow other users to improperly affect presentation of a sponsored content item by specific interactions with the sponsored content item for the specific benefit of the other users. Applying the machine learning model to sponsored content items to determine quality ratios for the sponsored content items allows the online system to determine a measure of quality of the sponsored content items that is not subject to being skewed by user manipulation through specific interactions with the sponsored content items.

After storing the machine learning model, when the online system identifies an opportunity to present content to a viewing user, the online system identifies one or more sponsored content items eligible for presentation to the viewing user. For example, the online system identifies one or more sponsored content items and applies the machine learning model to the identified sponsored content items, generating determined quality scores for the identified sponsored content items. At least one of the identified sponsored content items and its determined quality ratio is included in one or more selection processes performed by the online system to select content for presentation via the identified opportunity.

In various embodiments, a selection process including an identified sponsored content item generates an expected value of the identified sponsored content item to the online system. The online system adjusts the expected value of the identified sponsored content item based on the determined quality ratio. For example, the online system decreases the expected value of the identified sponsored content item in response to the determined quality ratio for the identified sponsored content item equaling or exceeding a threshold value. In another example, the online system increases the expected value of the identified sponsored content item in response to the determined quality ratio for the identified sponsored content item being less than a threshold value. Alternatively, the online system decreases the expected value of the identified sponsored content item in response to the determined quality ratio for the identified sponsored content item equaling or exceeding a threshold value and increases the expected value of the identified sponsored content item in response to the determined quality ratio for the identified sponsored content item being less than a different threshold value.

In some embodiments, a selection process including the identified sponsored content item ranks content items for presentation to the viewing user based on expected values of the content items to the online system and based on the adjusted expected value of the identified sponsored content item. Thus, adjustment of the expected value of the identified sponsored content item affects a position of the identified sponsored content item in the ranking. If the sponsored content item has at least a threshold position in the ranking, the online system displays the sponsored content item to the viewing user via the identified opportunity. For example, the online system includes the sponsored content item in a feed of content generated for the viewing user. By adjusting the expected value of the identified sponsored content item based on the determined quality ratio, the online system accounts for the determined quality ratio of a sponsored content item when determining whether to present the sponsored content item to a user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an example neural network model that may be used to determine a quality ratio for a sponsored content item, in accordance with an embodiment

FIG. 4 is a flowchart of a method for generating a quality ratio of sponsored content items based on characteristics of sponsored content items and prior interactions by users identifying low quality sponsored content items, in accordance with an embodiment.

FIG. 5 is a process flow diagram of an online system using a machine learning model to determine a quality ratio for a sponsored content item from characteristics of the sponsored content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

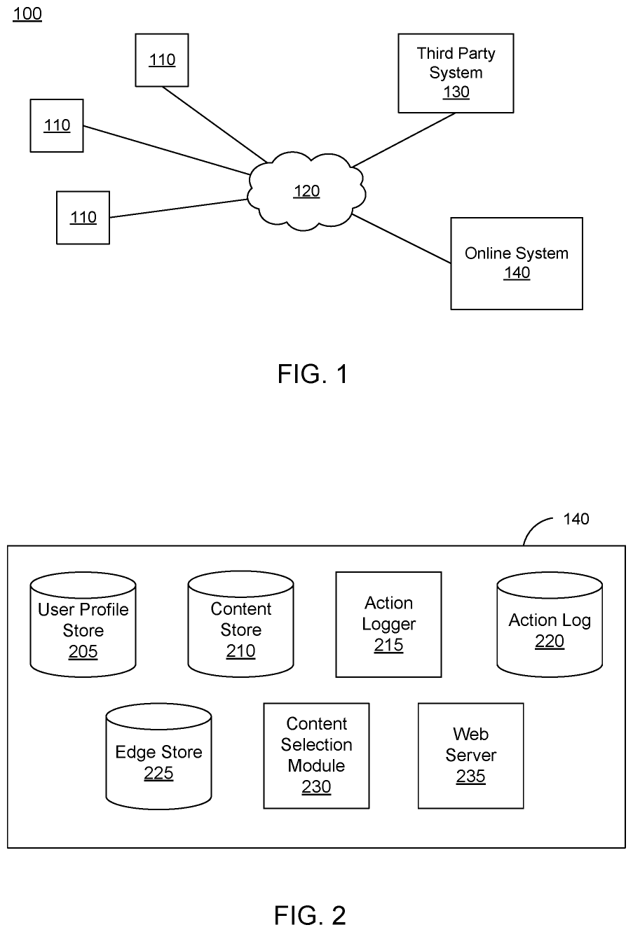

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 are “sponsored content items” that include content for presentation to a user and a bid amount. The content is text, image, audio, video, or any other suitable data presented to a user. In various embodiments, the content also specifies a page of content. For example, a sponsored content item includes a landing page specifying a network address of a page of content to which a user is directed when the content item is accessed. The bid amount is included in a sponsored content item by a user and is used to determine an expected value, such as monetary compensation, provided by the user to the online system 140 if content in the sponsored content item is presented to a viewing user, if the content in the sponsored content item receives an interaction from the viewing user when presented, or if any suitable condition is satisfied when content in the sponsored content item is presented to a user. For example, the bid amount included in a sponsored content item specifies a monetary amount that the online system 140 receives from a user who provided the sponsored content item to the online system 140 if content in the sponsored content item is displayed. In some embodiments, the expected value to the online system 140 of presenting the content from the sponsored content item may be determined by multiplying the bid amount by a probability of the content of the content item being accessed by a user.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items, such as sponsored content items, may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item, such as a sponsored content item, may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

Additionally, in various embodiments, the content store 210 includes one or more content reels, with each content reel including one or more content items. A content reel includes one or more content items and an order in which the content items are displayed when the content reel is displayed. A user selects content items for inclusion in a content reel, and the content store 210 stores an identifier of content reel in association with an identifier of the user and with identifiers of content items included in the content reel, and the order in which the content items are to be displayed. In various embodiments, content items are included in a content reel for a specific amount of time, and a content item is removed from the content reel after the specific amount of time from the inclusion of the content item in the content reel. For example, the online system 140 removes an association between an identifier of a content item and an identifier of a content reel 24 hours after a time when the content item was included in the content reel by a user associated with the content reel.

The action logger 215 receives communications about user actions (or “interactions”) internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220. Other example actions include a user hiding a content item displayed by the online system 140 to the user or reporting a content item displayed by the online system 140 as inappropriate or offensive.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a reaction to an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

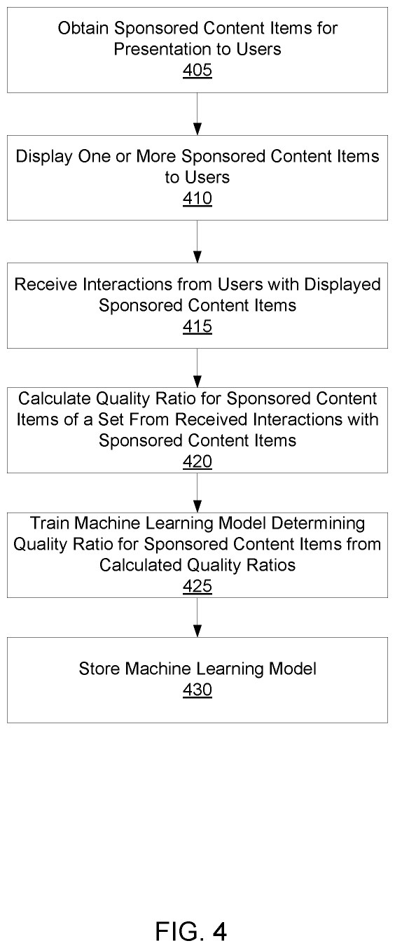

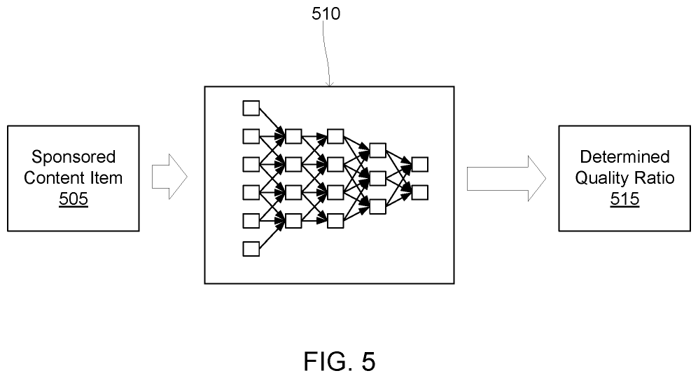

In various embodiments, the content selection module 230 maintains one or more criteria to regulate display of sponsored content items. As further described below in conjunction with FIGS. 4 and 5, the content selection module 230 generates a machine learning model that determines a quality ratio of a sponsored content item from characteristics of the sponsored content item. In various embodiments, the quality ratio for a sponsored content item is a ratio of a predicted number of times the sponsored content item would be reported to the online system 140 when displayed to a sum of the predicted number of times the sponsored content item would be reported to the online system 140 when displayed and a predicted number of times the sponsored content item would be hidden by users when displayed. As further described below in conjunction with FIG. 4, the content selection module 230 generates the machine learning model from prior interactions by users with sponsored content items that have been presented to the users.

A quality ratio determined for a sponsored content item is used by one or more selection processes that the content selection module 230 uses to select content for presentation to a user. For example, the content selection module 230 increases an expected value of a sponsored content item or a measure of relevance of the sponsored content item to a user if the determined quality ratio for the sponsored content item is less than a threshold value. In another example, the content selection module 230 decreases an expected value of a sponsored content item or a measure of relevance of the sponsored content item to a user if the determined quality ratio for the sponsored content item equals or exceeds a threshold value. This allows the content selection module 230 to account for a measure of quality of sponsored content items, from their determined quality ratios, when selecting sponsored content items for presentation to a user, increasing a likelihood of the user being presented with sponsored content items that are relevant to the user or with which the user is likely to interact (i.e., higher quality sponsored content items).

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Accounting for Prior User Indications of Sponsored Content Item Quality when Selecting Sponsored Content Items

As described above in conjunction with FIG. 2, the content selection module 230 includes a machine learning model configured to generate a quality ratio for a sponsored content item based on characteristics of the sponsored content item. In some embodiments, the machine learning model identifies characteristics of a sponsored content item. Example characteristics of a sponsored content item include words or phrases included in the sponsored content item, one or more keywords or topics associated with the sponsored content item, objects identified by or included in the sponsored content item, objects included in one or more images included in the sponsored content item, a landing page included in the sponsored content item, and a user from whom the sponsored content item was received.

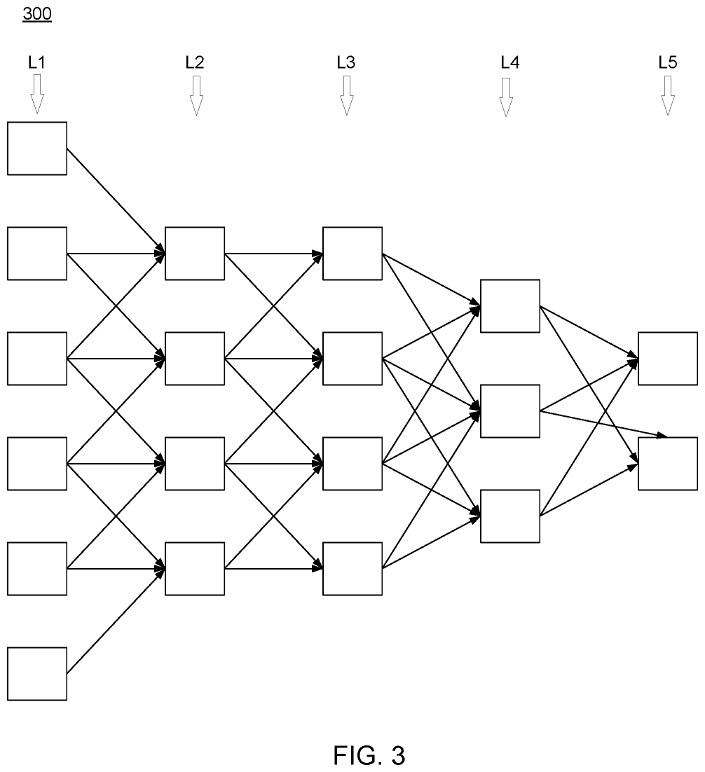

In some embodiments, the machine learning model is a neural network model. FIG. 3 shows an example neural network model 300 that may be used to identify characteristics of a sponsored content item. The neural network model 300 shown in FIG. 3, also referred to as a deep neural network, comprises a plurality of layers (e.g., layers L1 through L5), with each of the layers including one or more nodes. Each node has an input and an output, and is associated with a set of instructions corresponding to the computation performed by the node. The set of instructions corresponding to the nodes of the neural network may be executed by one or more computer processors.

Each connection between nodes in the neural network model 300 may be represented by a weight (e.g., numerical parameter determined through a training process). In some embodiments, the connection between two nodes in the neural network model 300 is a network characteristic. The weight of the connection may represent the strength of the connection. In some embodiments, connections between a node of one level in the neural network model 300 are limited to connections between the node in the level of the neural network model 300 and one or more nodes in another level that is adjacent to the level including the node. In some embodiments, network characteristics include the weights of the connection between nodes of the neural network. The network characteristics may be any values or parameters associated with connections of nodes of the neural network.

A first layer of the neural network 300 (e.g., layer L1 in FIG. 3) may be referred to as an input layer, while a last layer (e.g., layer L5 in FIG. 3) may be referred to an output layer. The remaining layers (layers L2, L3, L4) of the neural network 300 are referred to are hidden layers. Nodes of the input layer are correspondingly referred to as input nodes; nodes of the output layer are referred to as output nodes, and nodes of the hidden layers are referred to as hidden nodes. Nodes of a layer provide input to another layer and may receive input from another layer. For example, nodes of each hidden layer (L2, L3, L4) are associated with two layers (a previous layer and a next layer). A hidden layer (L2, L3, L4) receives an output of a previous layer as input and provides an output generated by the hidden layer as an input to a next layer. For example, nodes of hidden layer L3 receive input from the previous layer L2 and provide input to the next layer L4.

The layers of the neural network 300 are configured to identify one or more characteristics of a received sponsored content item. In some embodiments, the layers of the neural network 300 perform classification on the received sponsored content item (e.g., determine a probability that the received sponsored content item is associated with a topic or keyword). For example, an output of the last hidden layer of the neural network 300 (e.g., the last layer before the output layer, illustrated in FIG. 3 as layer L4) indicates one or more characteristics of the received sponsored content item. The output layer of the neural network 300 may output one or more scores associated with the received sponsored content item. For example, each of the output scores may correspond to a probability that received sponsored content item has a different quality ratio.

In some embodiments, the weights between different nodes in the neural network 300 may be updated using machine learning techniques. For example, the neural network 300 receives a set of training sponsored content items for which quality ratios were previously determined based on user interactions with different training sponsored content items of the set. For example, a quality ratio of a training sponsored content item a ratio of a number of times users reported the training sponsored content item as inappropriate to a sum of the number of times users reported the training sponsored content item as inappropriate and a number of times users hid the training sponsored content item. Each training sponsored content item is labeled with the quality ratio previously determined for the training sponsored content item. In some embodiments, the training set comprises a set of sponsored content items presented to at least a threshold number of users of the online system 140 or sponsored content items presented to users of the online system 140 for at least a threshold amount of time; each sponsored content item of the training set is associated with a corresponding label identifying a quality ratio determined for the sponsored content item from prior user interactions with the sponsored content item. Characteristics of each training sponsored content item determined by the neural network 300 (e.g., a quality ratio determined for a training sponsored content item) are compared to the quality ratio determined for the corresponding training sponsored content item from prior interactions with the training sponsored content item, and the comparison is used to modify one or more weights between different nodes in the neural network 300.

FIG. 4 is a flowchart of one embodiment of a method for generating a quality ratio of sponsored content items based on characteristics of sponsored content items and prior interactions by users identifying low quality sponsored content items. In various embodiments, the method may include different or additional steps than those described in conjunction with FIG. 3. Additionally, in some embodiments, the method may perform the steps in different orders than the order described in conjunction with FIG. 3.

An online system 140, as further described above in conjunction with FIGS. 1 and 2, obtains 405 content items from one or more users for presentation to other users. A content item obtained 405 from a user includes text data, audio data, image data, video data, or any combination thereof for presentation to other users via the online system 140. One or more of the content items obtained 405 by the online system 140 are sponsored content items. As further described above in conjunction with FIG. 2, a sponsored content item includes content for presentation to a user and a bid amount specifying an amount of compensation received by the online system 140 from a user from whom the online system 140 obtained 405 the sponsored content item if content from the sponsored content item is displayed to another user or if the other user performs a specific action after the content from the sponsored content item is displayed to the other user.

The online system 140 displays 410 one or more of the sponsored content items to users of the online system 140 and receives 415 interactions by users with sponsored content items form the set. For example, the online system 140 includes one or more sponsored content item in a feed of content generated for a user; the feed of content includes content items for which the online system 140 does not receive compensation for displaying, as well as one or more of the sponsored content items. As further described above in conjunction with FIG. 2, when a user interacts with a sponsored content item from the set via a client device 110, the client device 110 transmits an identifier of the user, an identifier of the sponsored content item of the set, and a description of the interaction to the online system 140. The online system 140 stores the description of the interaction in association with the identifier of the user and the identifier of the sponsored content item, allowing the online system 140 to maintain a log of various interactions with the sponsored content item.

Certain interactions by users with sponsored content indicate that users perceive the sponsored content items to be of low quality, such as uninteresting, irrelevant, or offensive content. For example, a user hides a sponsored content item after being presented with the sponsored content item. As another example, a user reports a sponsored content item to the online system 140 to indicate that the user finds the sponsored content item to be inappropriate or offensive. When reporting a sponsored content item to the online system 140, a user identifies the sponsored content item and provides a reason for reporting the sponsored content item (e.g., the user finds the sponsored content item to be offensive, inappropriate, misleading, prohibited content, etc.) in some embodiments. Alternatively, a user identifies the sponsored content item and reports the sponsored content item to the online system 140 without providing a reason for reporting the sponsored content item. In other embodiments, users may perform any other suitable interaction with a sponsored content item to indicate that the user considers the sponsored content item to be of low quality.

When presenting content to users, the online system 140 accounts for perceived quality of the content items by various users to present content items to users with which the users are more likely to interact. However, quality of a content item is subjective to individual users. For example, a user hides a particular sponsored content item because it is related to a topic that is not relevant to the user, while the particular sponsored content item is related to a topic that is highly relevant to another user. To account for varying user assessments of quality of a sponsored content item to different users, the online system 140 accounts for different types of interactions by users with sponsored content items to calculate 420 a quality ratio for different sponsored content items. In various embodiments, the online system 140 uses a number of times that a content item has been reported to the online system 140 by users and a number of times that the content item has been hidden by users when presented to calculate 420 the quality ratio. As an example, the online system 140 calculates 420 the quality ratio for a content item as a ratio of a number of times that the content item has been reported to the online system 140 by users to a sum of the number of times that the content item has been hidden by users and the number of times that the content item has been reported to the online system 140. The online system 140 may calculate 430 the quality ratio for a sponsored content item based on interactions with the content item within a specific time interval, such as within a threshold amount of time from a time when the quality ratio is calculated 430, in some embodiments. Alternatively, the online system 140 calculates 430 the quality ratio from cumulative interactions with a sponsored content item that the online system 140 received 415 since the online system 140 initially displayed 410 the sponsored content item to a user to the time when the online system 140 calculates 420 the quality ratio.

From quality ratios calculated 420 for each of a set of content items displayed 410 to users, the online system 140 trains 425 a machine learning model that determines a quality ratio for a sponsored content item based on characteristics of sponsored content items. The online system 140 trains 425 the machine learning model from characteristics of each content item of the set and corresponding quality ratios calculated for each content item of the set. In various embodiments, the online system 140 selects the set of content items as content items that have been displayed 410 to at least a threshold number of users. Alternatively, the online system 140 selects the set of content items as content items for which the online system 140 has received 415 at least a threshold number of interactions. In another example, the online system 140 selects the set of content items as content items that have been displayed 410 to users for at least a threshold amount of time. However, the online system 140 may select the set of content items using any suitable criteria in various embodiments.

To train 425 the machine learning model that determines a quality ratio for a sponsored content item, the online system 140 fits the machine learning model to the set of sponsored content items and their previously calculated quality ratios. For example, the online system 140 may use back propagation to train 425 the model if it is a neural network, or the online system 140 may use curve fitting techniques if the model is a linear regression. Application of the machine learning model to a content item of the set determines quality ratio of the sponsored content item determined (i.e., a “determined quality ratio”) from characteristics of the sponsored content item of the set. Hence, application of the machine learning model to the sponsored content items of the set generates a determined quality ratio for different sponsored content items of the set. The machine learning model may user any suitable characteristics of a sponsored content item of the set to generate the determined quality ratio for the sponsored content item in various embodiments (such as previous interactions with other sponsored content items obtained from the same user, with other sponsored content items having a common topic or keyword, or with other sponsored content items having at least a threshold number of targeting criteria matching targeting criteria of the sponsored content item).

For each sponsored content item of the set to which the machine learning model was applied, the online system 140 compares the determined quality ratio of the sponsored content item of the set to the quality ratio calculated 420 for the sponsored content item of the set from the interactions with the sponsored content item of the set. Based on comparison of the determined quality ratio for the sponsored content item of the set to the quality ratio calculated 420 from received 415 interactions with the sponsored content item of the set, the online system 140 updates the machine learning model. For example, based on the comparison of the determined quality ratio for the sponsored content item of the set to the quality ratio calculated 420 from received 415 interactions with the sponsored content item of the set, the online system 140 modifies one or more weights between nodes in a neural network model, as further described above in conjunction with FIG. 3. For example, the online system 140 uses multi-class logistic regression to modify one or more weights between nodes in a neural network model based on differences between the determined quality ratio for the sponsored content item of the set to the quality ratio calculated 420 from received 415 interactions with the sponsored content item of the set. In the preceding example, the online system 140 iteratively applies the updated machine learning model to each sponsored content item of the set, compares the determined quality ratio for a sponsored content item of the set to the quality ratio calculated 420 for the sponsored content item of the set from received 415 interactions with the sponsored content item of the set, and modifies weights between nodes of the updated machine learning model based on the comparison until the machine learning model has been applied to the sponsored content items of the set a specific number of times or until differences between a determined quality ratio for the sponsored content item of the set to the quality ratio calculated 420 for the sponsored content item from received 415 interactions with the sponsored content item of the set do not exceed a threshold difference. The online system 140 subsequently stores 430 the generated machine learning model.

Training the machine learning model allows the online system 140 to determine a quality ratio for a sponsored content item based on characteristics of the sponsored content item rather than from received interactions with the sponsored content item. This prevents users from biasing the quality ratio for a sponsored content item by hiding or by reporting the sponsored content item a disproportionate number of times. For example, when the online system 140 displays 410 a sponsored content item from a publishing user to other users, users competing with the publishing user hide and report the sponsored content item, resulting in numbers of times the sponsored content item was hidden or was reported that is disproportionately high. This may allow other users to improperly affect presentation of a sponsored content item by specific interactions with the sponsored content item. Determining the quality ratio of a sponsored content item by application of the machine learning model to the sponsored content item allows the online system 140 to determine a measure of quality of the sponsored content items to various users that is not subject to being skewed by user manipulation by performing specific interactions used when determining the quality ratio. Further, because the quality ratio is determined from characteristics of the sponsored content items via a machine learning model generated from prior user interactions, the determined quality ratio is less influenced by subjective assessment by individual reviewers.

In various embodiments, the online system 140 updates the stored machine learning model over time as additional sponsored content items are displayed to users of the online system 140. For example, after displaying additional sponsored content items to users and receiving interactions by the users with the additional sponsored content items, the online system 140 calculates the quality ratio for various additional sponsored content items, as further described above. In some embodiments, the online system 140 calculates a quality ratio for an additional sponsored content item in response to the additional sponsored content item being presented to a threshold number of users, in response to the additional content item being presented for at least a threshold amount of time, or in response to the online system 140 receiving at least a threshold number of interactions with the additional sponsored content item. The online system 140 applies the machine learning model to the additional content item and compares the determined quality ratio from the machine learning model the quality ratio for the additional content item. As further described above, the online system 140 updates the machine learning model based on the comparison and stores the updated machine learning model for subsequent application to sponsored content items.

After storing the machine learning model, when the online system 140 identifies an opportunity to present content to a viewing user, the online system 140 identifies one or more sponsored content items eligible for presentation to the viewing user. For example, the online system 140 identifies one or more sponsored content items including at least a threshold amount of targeting criteria satisfied by characteristics of the viewing user or identifies one or more sponsored content items that do not include targeting criteria. The online system 140 applies the machine learning model to the identified sponsored content items, generating determined quality scores for the identified sponsored content items. At least one of the identified sponsored content items is included in one or more selection processes, as further described above in conjunction with FIG. 2, along with the determined quality ratio for the sponsored content item.

In various embodiments, a selection process including an identified sponsored content item generates an expected value of the identified sponsored content item to the online system. For example, the expected value of the identified sponsored content item to the online system is a product of a likelihood of the viewing user interacting with the sponsored content item, as further described above in conjunction with FIG. 2, and the bid amount included in the sponsored content item. The online system 140 adjusts the expected value of the identified sponsored content item based on the determined quality ratio. For example, the online system 140 decreases the expected value of the identified sponsored content item in response to the determined quality ratio for the identified sponsored content item equaling or exceeding a threshold value. In another example, the online system 140 increases the expected value of the identified sponsored content item in response to the determined quality ratio for the identified sponsored content item being less than a threshold value. Alternatively, the online system 140 decreases the expected value of the identified sponsored content item in response to the determined quality ratio for the identified sponsored content item equaling or exceeding a threshold value and increases the expected value of the identified sponsored content item in response to the determined quality ratio for the identified sponsored content item being less than a different threshold value.

In some embodiments, a selection process including the identified sponsored content item ranks content items for presentation to the viewing user based on expected values of the content items to the online system and based on the adjusted expected value of the identified sponsored content item. Thus, adjustment of the expected value of the identified sponsored content item affects a position of the identified sponsored content item in the ranking. If the sponsored content item has at least a threshold position in the ranking, the online system 140 displays the sponsored content item to the viewing user via the identified opportunity. For example, the online system 140 includes the sponsored content item in a feed of content generated for the viewing user. By adjusting the expected value of the identified sponsored content item based on the determined quality ratio, the online system 140 accounts for the determined quality ratio of a sponsored content item when determining whether to present the sponsored content item to a user.

FIG. 5 shows a process flow diagram of one embodiment of an online system 140 using a machine learning model to determine a quality ratio for a sponsored content item. In the example of FIG. 5, the online system 140 obtains a sponsored content item 505 and applies a machine learning model 510 to the sponsored content item 505. As further described above in conjunction with FIG. 4, the machine learning model 510 outputs a determined quality ratio 515 for the sponsored content item 505 based on characteristics of the sponsored content item 505. The determined quality ratio 515 represents an expected ratio of different types of interactions with the sponsored content item 505. For example, the determined quality ratio 515 is a ratio of a predicted number of times the sponsored content item 505 is reported to the online system 140 when displayed to users to a sum of the predicted number of times the sponsored content item 505 is reported to the online system 140 when displayed to users and a predicted number of times the sponsored content item 505 is hidden by users to whom the sponsored content item 505 is displayed. As further described above in conjunction with FIG. 4, the online system 140 accounts for the determined quality ratio for the sponsored content item 505 when determining whether to display the sponsored content item 505 to a user of the online system 140.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
obtaining one or more sponsored content items at an online system, each sponsored content item including content and a bid amount specifying an amount of compensation received by the online system;
displaying one or more of the sponsored content items to users of the online system;
receiving, at the online system, interactions with the displayed one or more sponsored content items by the users, where the interactions include reporting a sponsored content item to the online system or interacting with the sponsored content item to hide the sponsored content item;
calculating a quality ratio for each sponsored content item of a set of the displayed one or more content items from received interactions with the sponsored content item of the set, the quality ratio for a sponsored content item of the set comprising a ratio of a number of times users reported the sponsored content item of the set to the online system to a sum of the number of times users reported the sponsored content item of the set and a number of times users hid the sponsored content item of the set;
training a machine learning model for generating a determined quality ratio for a sponsored content item from characteristics of sponsored content items of the set and quality ratios calculated for sponsored content items of the set; and
storing the machine learning model at the online system.

2. The method of claim 1, further comprising:
identifying an opportunity to present content to a viewing user of the online system;
generating determined quality scores for one or more of the obtained sponsored content items by applying the machine learning model to the one or more of the obtained sponsored content items;
including an identified sponsored content item and a determined quality ratio for the identified sponsored content item in one or more selection processes applied by the online system to select content for presentation to the viewing user via the identified opportunity.

3. The method of claim 2, wherein including the identified sponsored content item and the determined quality ratio for the identified sponsored content item in one or more selection processes applied by the online system to select content for presentation to the viewing user via the identified opportunity comprises:
generating an expected value of the identified sponsored content item to the online system from a likelihood of the viewing user interacting with the identified sponsored content item and a bid amount included in the identified sponsored content item; and
adjusting the expected value of the identified sponsored content item based on the determined quality ratio for the identified sponsored content item.

4. The method of claim 3, wherein adjusting the expected value of the identified sponsored content item based on the determined quality ratio for the identified sponsored content item comprises:
decreasing the expected value of the identified sponsored content item in response to the determined quality ratio for the identified sponsored content item equaling or exceeding a threshold value.

5. The method of claim 3, wherein adjusting the expected value of the identified sponsored content item based on the determined quality ratio for the identified sponsored content item comprises:
increasing the expected value of the identified sponsored content item in response to the determined quality ratio for the identified sponsored content item being less than a threshold value.

6. The method of claim 3, wherein including the identified sponsored content item and the determined quality ratio for the identified sponsored content item in one or more selection processes applied by the online system to select content for presentation to the viewing user via the identified opportunity further comprises:
ranking the identified sponsored content item and other content items based on expected values to the online system of the other content items and the adjusted expected value of the identified sponsored content item; and
displaying the identified sponsored content item to the viewing user via the identified opportunity in response to the sponsored content item having at least a threshold position in the ranking.

7. The method of claim 1, further comprising:
displaying one or more additional sponsored content items to users of the online system;
calculating the quality ratio for each of one or more of the additional sponsored content items from received interactions with the sponsored content item of the set; and
updating the machine learning model based on a comparison of the calculated quality ratios for the one or more additional content items to corresponding determined quality ratios for the one or more additional content items from applying the machine learning model to the one or more additional content items.

8. The method of claim 1, wherein the set of the displayed one or more content items comprises content items displayed to at least a threshold number of users of the online system.

9. The method of claim 1, wherein the set of the displayed one or more content items comprises content items for which the online system received at least a threshold number of interactions.

10. The method of claim 1, wherein the set of the displayed one or more content items comprises content items displayed to users of the online system for at least a threshold amount of time.

11. A computer program product comprising a non-transitory computer readable storage medium having instructions encoded thereon that, when executed by a processor cause the processor to:
obtain one or more sponsored content items at an online system, each sponsored content item including content and a bid amount specifying an amount of compensation received by the online system;
display one or more of the sponsored content items to users of the online system;
receive, at the online system, interactions with the displayed one or more sponsored content items by the users, where the interactions include reporting a sponsored content item to the online system or interacting with the sponsored content item to hide the sponsored content item;
calculate a quality ratio for each sponsored content item of a set of the displayed one or more content items from received interactions with the sponsored content item of the set, the quality ratio for a sponsored content item of the set comprising a ratio of a number of times users reported the sponsored content item of the set to the online system to a sum of the number of times users reported the sponsored content item of the set and a number of times users hid the sponsored content item of the set;
train a machine learning model for generating a determined quality ratio for a sponsored content item from characteristics of sponsored content items of the set and quality ratios calculated for sponsored content items of the set; and
storing the machine learning model at the online system.

12. The computer program product of claim 11, wherein the non-transitory computer readable storage medium further has instructions encoded thereon that, when executed by the processor, cause the processor to:
identify an opportunity to present content to a viewing user of the online system;
generate determined quality scores for one or more of the obtained sponsored content items by applying the machine learning model to one or more of the obtained sponsored content items;
include an identified sponsored content item and a determined quality ratio for the identified sponsored content item in one or more selection processes applied by the online system to select content for presentation to the viewing user via the identified opportunity.

13. The computer program product of claim 12, wherein include the identified sponsored content item and the determined quality ratio for the identified sponsored content item in one or more selection processes applied by the online system to select content for presentation to the viewing user via the identified opportunity comprises:
generate an expected value of the identified sponsored content item to the online system from a likelihood of the viewing user interacting with the identified sponsored content item and a bid amount included in the identified sponsored content item; and
adjust the expected value of the identified sponsored content item based on the determined quality ratio for the identified sponsored content item.

14. The computer program product of claim 13, wherein adjust the expected value of the identified sponsored content item based on the determined quality ratio for the identified sponsored content item comprises:
decrease the expected value of the identified sponsored content item in response to the determined quality ratio for the identified sponsored content item equaling or exceeding a threshold value.

15. The computer program product of claim 13, wherein adjust the expected value of the identified sponsored content item based on the determined quality ratio for the identified sponsored content item comprises:
increase the expected value of the identified sponsored content item in response to the determined quality ratio for the identified sponsored content item being less than a threshold value.

16. The computer program product of claim 13, wherein include the identified sponsored content item and the determined quality ratio for the identified sponsored content item in one or more selection processes applied by the online system to select content for presentation to the viewing user via the identified opportunity further comprises:
rank the identified sponsored content item and other content items based on expected values to the online system of the other content items and the adjusted expected value of the identified sponsored content item; and
display the identified sponsored content item to the viewing user via the identified opportunity in response to the identified sponsored content item having at least a threshold position in the ranking.

17. The computer program product of claim 11, wherein the non-transitory computer readable storage medium further has instructions encoded thereon that, when executed by the processor, cause the processor to:
display one or more additional sponsored content items to users of the online system;
calculating the quality ratio for each of one or more of the additional sponsored content items from received interactions with the sponsored content item of the set; and
update the machine learning model based on a comparison of the calculated quality ratios for the one or more additional content items to corresponding determined quality ratios for the one or more additional content items from applying the machine learning model to the one or more additional content items.

18. The computer program product of claim 11, wherein the set of the displayed one or more content items comprises content items displayed to at least a threshold number of users of the online system.

19. The computer program product of claim 11, wherein the set of the displayed one or more content items comprises content items for which the online system received at least a threshold number of interactions.

20. The computer program product of claim 11, wherein the set of the displayed one or more content items comprises content items displayed to users of the online system for at least a threshold amount of time.

21. The method of claim 1, wherein the machine learning model is configured as a neural network model, and training the machine learning model comprises:
determining a comparison between quality ratios for the sponsored content items of the set that were determined by the machine learning model and the quality ratios calculated for the sponsored content items of the set, and
performing back propagation to update weights of the machine learning model.

22. The computer program product of claim 11, wherein the machine learning model is configured as a neural network model, and training the machine learning model comprises:
determining a comparison between quality ratios for the sponsored content items of the set that were determined by the machine learning model and the quality ratios calculated for the sponsored content items of the set, and
performing back propagation to update weights of the machine learning model.
